(19) United States
(12) Patent Application Publication
(10) Pub. No.: US 2023/0390968 A1
(43) Pub. Date: Dec. 7, 2023

(54) MANUFACTURING MOLD FOR MANUFACTURING A CABLE HARNESS, SYSTEM, AND METHOD

(71) Applicant: YAZAKI SYSTEMS TECHNOLOGIES GMBH, Regensburg (DE)

(72) Inventor: Aldo NAVARRO MÁLAGA, Esslingen am Neckar (DE)

(73) Assignee: YAZAKI SYSTEMS TECHNOLOGIES GMBH, Regensburg (DE)

(21) Appl. No.: 18/454,470

(22) Filed: Aug. 23, 2023

Related U.S. Application Data
(63) Continuation of application No. PCT/EP22/54707, filed on Feb. 24, 2022.

(30) Foreign Application Priority Data
Feb. 24, 2021 (DE) 102021104405.7

(51) Int. Cl. B29C 33/12; H01B 13/012; B29C 44/12; B29C 33/24; B29C 33/30

(52) U.S. Cl. CPC B29C 33/126; H01B 13/01209; B29C 44/1271; B29C 33/24; B29C 33/303; B29L 2031/3462

(57) ABSTRACT

A manufacturing mold for manufacturing a cable harness for a vehicle and a related method and system. The mold comprises a mold body and at least a first actuator, the mold body is made from an elastically reversibly deformable material and at least partially surrounds a mold cavity, the first actuator is coupled to a first portion of the mold body, the first portion at least partially delimits the mold cavity on the inside, the cable harness can at least be manufactured in the mold cavity, and the first actuator is designed to reversibly pivot the first portion between a first position and a second position that is different from the first position.

### CROSS REFERENCE TO RELATED APPLICATIONS

This application is a Rule 53(b) Bypass Continuation of International Application No. PCT/EP2022/054707 filed Feb. 24, 2022, claiming priority based on German Patent Application No. 10 2021 104 405.7 filed Feb. 24, 2021, the disclosures of which are incorporated herein by reference in their entireties.

### BACKGROUND OF THE INVENTION

### Field of the Invention

The invention relates to an adaptable manufacturing mold for manufacturing a cable harness, a system and a method.

### BACKGROUND

A manufacturing mold for manufacturing a cable harness is disclosed in U.S. Pat. No. 6,086,037.

### SUMMARY OF THE INVENTION

It is the object of the invention to provide an improved manufacturing mold, an improved system and an improved method.

This object is achieved by means of a manufacturing mold according as claimed and described herein.

It has been recognized that a particularly suitable manufacturing mold for manufacturing a cable harness for a means, in particular a vehicle or a machine, can be provided by the manufacturing mold having a mold body and at least a first actuator. The mold body is made from a one-piece, one-material, elastically reversibly deformable material (at 20° C.). The mold body at least partially surrounds a mold cavity. The first actuator is coupled, in particular connected, to a first portion of the mold body. The first portion at least partially delimits the mold cavity on the inside. The cable harness can at least be manufactured in the mold cavity, wherein the first actuator is configured to reversibly pivot, in particular to deform, the first portion between a first position and a second position that is different from the first position.

This design has the advantage that, due to the deformability, the manufacturing mold can be adapted by means of the actuator and can be tailored to the given circumstances or individual method steps in a simple manner for manufacturing a cable harness. In particular, by means of the actuator the geometric design of the mold body can be adapted by the deformation in the first portion.

In a further embodiment, the mold body has an opening for introducing at least one electrical cable into the mold cavity. The opening opens into the mold cavity. The first portion adjoins the opening. In the second position of the first portion, the opening is widened relative to the first position of the first portion. This design has the advantage that an opening cross section of the opening can be widened and reduced in a switchable manner by the actuator, and as a result the insertion of the electrical cable into the mold cavity is particularly facilitated in the open state of the opening. In particular, an automated insertion of the electrical cable into the mold cavity is possible thereby. Additionally, in the first position of the first portion the situation is avoided that the electrical cable unintentionally slips out of the mold cavity. As a result, a particularly high level of process reliability can be ensured.

In a further embodiment, the mold body has a mold base, wherein in the first position the first portion is oriented parallel or inclined obliquely to the mold base, wherein in the second position the first portion is spaced further apart from the mold base than in the first position. It is particularly advantageous if in the second position the first portion of the mold base is bent away and/or pivoted away from the first position. In an alternative, in the second position the first portion is arranged closer to the mold base than in the first position. It is particularly advantageous if in the second position the first portion is bent or pivoted toward the mold base from the first position. A further deformation of the mold body can be substantially avoided by the bending and/or pivoting of the first portion.

In a further embodiment, the adaptable manufacturing mold has a second actuator, wherein the mold body has a second portion. The second portion is arranged offset to the first portion. The second actuator is arranged on and/or in the second portion, wherein the second actuator is configured to pivot, in particular to deform, the second portion reversibly between a third position and a fourth position which is different from the third position.

In a further embodiment, the opening extends in its main direction of extension in a first direction. The second portion is arranged opposite the first portion in a second direction perpendicular to the first direction. The second portion at least partially delimits the opening opposite the first portion. In the first position of the first portion and in the third position of the second portion the opening has a first minimum opening width in the second direction. In the second position of the first portion and in the fourth position of the second portion, the opening has a second minimum opening width in the second direction which is larger than the first opening width.

As a result, the opening can be widened to a particularly large degree by the two actuators for inserting the cable, so that the electrical cable can be inserted particularly easily both manually and in an automated manner. The first minimum opening width can be selected such that the first minimum opening width is smaller than a minimum external diameter of the smallest of the electrical cables. As a result, the situation is avoided that the electrical cable slips out of the mold cavity. The first minimum opening width can be selected such that the first portion and the second portion come into contact with one another and as a result the opening is entirely closed.

In a further embodiment, the first actuator is arranged on the outside of the mold body.

In a further embodiment, the first actuator is at least partially, preferably entirely, embedded in the mold body. The external arrangement of the first actuator on the mold body has the advantage that the adaptable manufacturing mold can be manufactured particularly simply and cost-effectively. The embedding of the first actuator in the mold body has the advantage that on the peripheral side the actuator is entirely enclosed by the first material of the mold body and thereby damage to the first actuator, for example due to liquids, can be avoided.

It is particularly advantageous if the mold body is configured in one piece and in one material.

In a further embodiment, the first actuator has at least one pressure chamber, wherein the pressure chamber can be filled with a pressurized pressure fluid in order to move the first portion between the first position and the second position.

In a further embodiment, the first actuator is configured as a dielectric elastomer actuator. As a result, the adaptable manufacturing mold can have a particularly thin wall thickness.

In a further embodiment, the first actuator is configured to deform the mold body in an elastically reversible manner when the first portion is pivoted between the first position and the second position. As a result, further mechanical joints can be dispensed with.

In a further embodiment, in the second position the first portion encloses an angle relative to the first position, wherein the angle is at least 20°, preferably at least 40°, preferably at least 60°.

A system for manufacturing the cable harness preferably has a control apparatus and the adaptable manufacturing mold which is configured as described above. The control apparatus is connected to the first actuator, wherein the control apparatus is configured to control the first actuator such that the first actuator moves the first portion between the first position and the second position.

By means of the system the manufacturing mold can be controlled in an automated manner and the cable harness can be manufactured in an automated manner.

Additionally, the system can have an insertion means which is controlled by the control apparatus in order to insert in an automated manner electrical cables into the mold cavity in cooperation with the adaptable manufacturing mold. The control apparatus controls the adaptable manufacturing mold and the insertion means such that they can manufacture the cable harness in cooperation with one another. The insertion means can be, for example, a robot arm, for example a six-axis robot. Alternatively, the insertion means can also be configured as an autonomously controlled vehicle or autonomously controlled aircraft, in order to insert the electrical cable or the electrical cables in cooperation with the adaptable manufacturing mold into the mold cavity of the adaptable manufacturing mold.

In a method for manufacturing the cable harness, the above-described adaptable manufacturing mold is provided, wherein the first actuator moves the first portion from the first position into the second position. At least a first electrical cable is inserted into the mold cavity for forming a cable bundle of the cable harness. Alternatively, at the same time a plurality of electrical cables can also be inserted as a cable bundle into the mold cavity. During the insertion of the first electrical cable, the first portion is in the second position. The first portion is advantageously located in the second position when the finished manufactured cable harness is removed from the mold cavity. As a result, the cable harness can be particularly easily demolded. The inserted cables can also be prevented from slipping out into the mold cavity.

It is particularly advantageous if, after the insertion of the first electrical cable into the mold cavity, the first actuator moves the first portion from the second position into the first position and in the first position the first portion secures the first electrical cable in the mold cavity. As a result, the situation is avoided that the electrical cable is unintentionally pushed out of the mold cavity, so that the electrical cable can be particularly effectively overmolded with a foamed material.

In a further embodiment, after the first electrical cable is inserted into the mold cavity the first actuator moves the first portion from the first position into the second position, wherein a foamed material is introduced into the mold cavity. The foamed material flows at least partially around the cable bundle such that the cable bundle is at least partially embedded in the foamed material. After the foamed material is introduced, the first actuator moves the first portion from the second position into the first position. This design has the advantage that, due to the first portion, the situation is avoided that the cable bundle floats on the foaming foamed material, so that a secure embedding of the cable bundle in the foamed material is ensured such that they are connected together via the foamed material. As a result, it is possible to dispense with wrapping the individual cables in a time-consuming manner in order to form the cable harness.

It is particularly advantageous if the first actuator is activated during the foaming of the foamed material such that the first actuator provides a counter-force which reduces or prevents the first portion bending up due to the foaming foamed material.

In a further embodiment, the foamed material is at least partially cured, wherein after the at least partial curing of the foamed material the first actuator moves the first portion from the first position into the second position, and the cable harness is removed from the mold cavity. This design has the advantage that the removal of the cable harness from the mold cavity can also take place in an automated manner and as a result the manufacturing costs are particularly low.

In a further embodiment, for inserting the first electrical cable into the mold cavity, the second actuator moves the second portion from the third position into the fourth position, wherein the first electrical cable is inserted into the mold cavity between the first portion and the second portion. As two actuators move the portions apart, the opening between the two portions is particularly large so that the first electrical cable or a plurality of electrical cables can be inserted particularly easily into the mold cavity for forming the cable harness. Moreover, when both portions are moved apart, the foamed material can be particularly effectively injection-molded into the mold cavity in order to connect together the electrical cables inserted in the mold cavity by means of the foamed material.

In a further embodiment, the first actuator deforms the mold body in an elastically reversible manner when the first portion is pivoted between the first position and the second position. As a result, the mold body can be configured in a particularly simple manner. In particular, mechanical components such as hinges can be dispensed with.

### BRIEF DESCRIPTION OF THE DRAWINGS

The invention is described in more detail hereinafter with reference to the figures, in which:

FIG. 1 shows a perspective schematic view of a system according to a first embodiment for the automated manufacture of a cable harness;

FIG. 2 shows a detail of a sectional view along a cutting plane A-A shown in FIG. 1 through the system shown in FIG. 1;

FIG. 3 shows a detail of a sectional view along a cutting plane B-B shown in FIG. 2 through the system shown in FIGS. 1 and 2;

FIG. 4 shows the detail shown in FIG. 3 of the sectional view along the cutting plane B-B shown in FIG. 1;

FIG. 5 shows a flow diagram of a method for the automated manufacture of the cable harness according to a first embodiment;

FIG. 6 shows a detail of a sectional view along the cutting plane B-B shown in FIG. 2 through the system during a third method step;

FIG. 7 shows a detail of a sectional view along the cutting plane B-B shown in FIG. 2 through the system after a fourth method step;

FIG. 8 shows a detail along a cutting plane B-B shown in FIG. 1 through the system shown in FIG. 1 during a second pass of the third method step;

FIG. 9 shows a detail along the cutting plane B-B shown in FIG. 2 through the system shown in FIG. 1 after a repeated pass of the third method step;

FIG. 10 shows a detail along the cutting plane B-B shown in FIG. 1 through the system during an eighth method step for manufacturing the cable harness;

FIG. 11 shows a detail of a sectional view along the cutting plane B-B shown in FIG. 2 through a system according to a second embodiment;

FIG. 12 shows the sectional view shown in FIG. 11 with the adaptable manufacturing mold shown in FIG. 11 in the open state;

FIG. 13 shows a detail of a sectional view along a cutting plane B-B shown in FIG. 1 through a system according to a third embodiment;

FIG. 14 shows a detail of a sectional view along the cutting plane B-B shown in FIG. 2 through a system according to a fourth embodiment.

### DETAILED DESCRIPTION OF THE INVENTION

In the following figures, reference is made to a coordinate system. The coordinate system has an x-axis (longitudinal direction), a y-axis (transverse direction) and a z-axis (vertical direction). The coordinate system is configured as a right-hand system by way of example. The coordinate system serves to describe the following figures in a simplified manner.

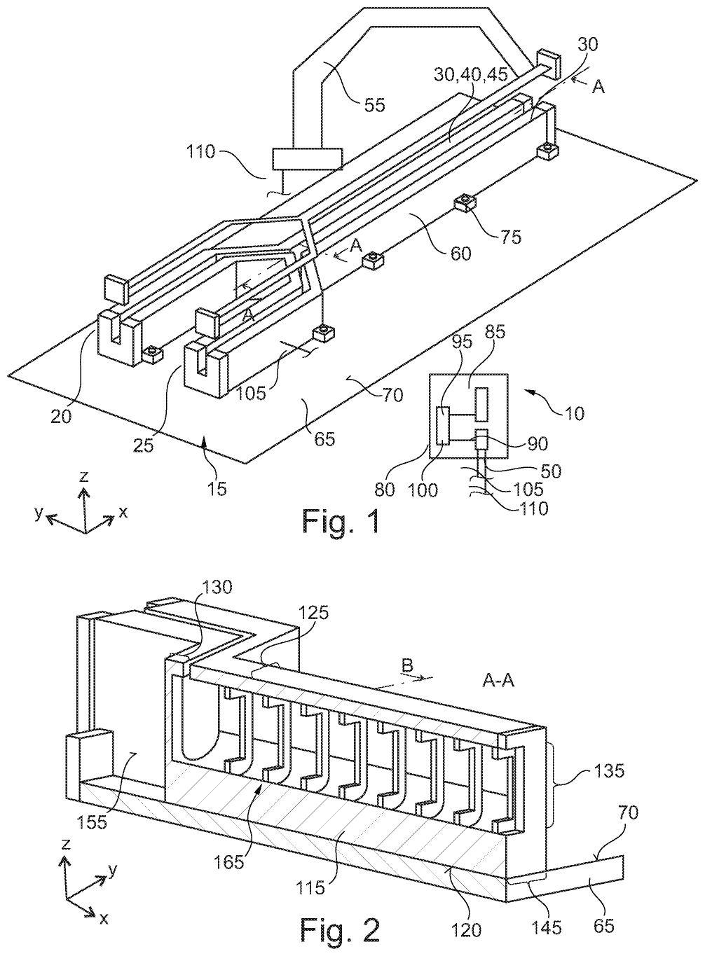

FIG. 1 shows a perspective schematic view of a system 10 according to a first embodiment for the automated manufacture of a cable harness 15.

The cable harness 15 is shown in FIG. 1 above an adaptable manufacturing mold 60 of the system 10. The cable harness 15 preferably serves for the electrical connection of various components in a motor vehicle, for example a control apparatus to actuators and/or sensors.

The cable harness 15 comprises one or more contact devices 20, 25, 30 (shown symbolically in FIG. 1) and a cable bundle 35 (shown in dashed-dotted lines in FIG. 1). The cable bundle 35 preferably has one or more electrical cables 40, 45. Each of the electrical cables 40, 45 has an electrically conductive conductor. The electrical conductor can have a wire or a plurality of wires, which are gripped in a bundle, for example twisted or running in a straight line, in a sheathing of the cable 45, 45.

The sheathing of the electrical conductor comprises an electrically non-conductive material and electrically insulates the electrical conductor from the other electrical cables 40, 45. The electrical conductor of the electrical cables 40, 45 is connected in each case to a contact element of the contact devices 20, 25, 30. In each case, the electrical conductor electrically connects the assigned contact elements of the contact devices 20, 25, 30 with one another.

The system 10 for manufacturing the cable harness 15 has by way of example a control apparatus 50, a laying device 55 and the adaptable manufacturing mold 60. Additionally, the system 10 can have a mold board 65 which is configured to be plate-shaped, for example.

The mold board 65 is arranged by way of example in an xy-plane, wherein the adaptable manufacturing mold 60 is fastened to the mold board 65 on a first upper side 70 of the mold board 65 by means of fastening means 75, which are configured for example as clamping bodies.

The design shown in FIG. 1 of the adaptable manufacturing mold 60 is by way of example. Naturally the adaptable manufacturing mold 60 can also have a different design.

The control apparatus 50 has a control device 80, a data storage device 85 and an interface 90. The control device 80 is connected in terms of data technology to the data storage device 85 by means of a first connection 95. The interface 90 is connected to the control device 80 by means of a second connection 100. Preferably, the second connection 100 is configured for data transmission. The interface 90 is connected to the adaptable manufacturing mold 60 by means of a third connection 105. The laying device 55 is connected to the interface 90 by means of a fourth connection 110. The first to fourth connections 95, 100, 105, 110 are preferably configured as a data connection and serve to transmit a data signal. A current for transmitting the data signal in the connection 95, 100, 105, 110 is relatively small, in particular less than 0.1 A. The third and fourth connections 105, 110, in particular, can also be part of a bus system, wherein the data signals are configured so as to correspond to the protocol with which the bus system operates. Electrical energy for the power supply can also be transmitted by means of the third and/or fourth connection 105, 110.

A control method, for example as a predefined algorithm, can be stored in the data storage device 85, for example a computer program for carrying out a method for manufacturing the cable harness 15 in a fully automated manner. On the basis of the algorithm retrieved via the first connection 95, the control device 80 controls the adaptable manufacturing mold 60 and the laying device 55 by means of control signals provided via the second connection 100 at the interface 90.

FIG. 2 shows a detail of a sectional view along a cutting plane A-A shown in FIG. 1 through the system 10 shown in FIG. 1.

The adaptable manufacturing mold 60 has a mold body 115. The mold body 115 has a first material which is elastically reversibly deformable at 20° Celsius, for example silicone and/or rubber and/or natural rubber and/or elastomer. It is also advantageous if the tensile strength of the first material ranges from 1 to 30 N/mm². In this case elastically reversible is understood to mean that the deformation of the first material of the mold body is reversible and does not lead to a permanent deformation, in contrast to a plastic deformation.

The mold body 115 is configured in the embodiment by way of example in one piece and in one material and thus comprises the elastically reversibly deformable first material over its entire extent. The adaptable manufacturing mold 60 can also have a plurality of mold bodies 115 which are arranged, for example, adjacent to one another and together form the adaptable manufacturing mold 60. Each body 115 is elastically reversibly deformable per se, preferably without this leading to a deformation, for example, of an adjacent neighboring mold body.

The mold body 115 is bears with a lower side 120 against the first upper side 70. The lower side 120 is configured to run in a planar manner in an xy-plane. The mold body 115 has a first portion 125 and a second portion 130 arranged opposite the first portion 125. In the sectioned region of the adaptable manufacturing mold 60, the second portion 130 is not shown in FIG. 2.

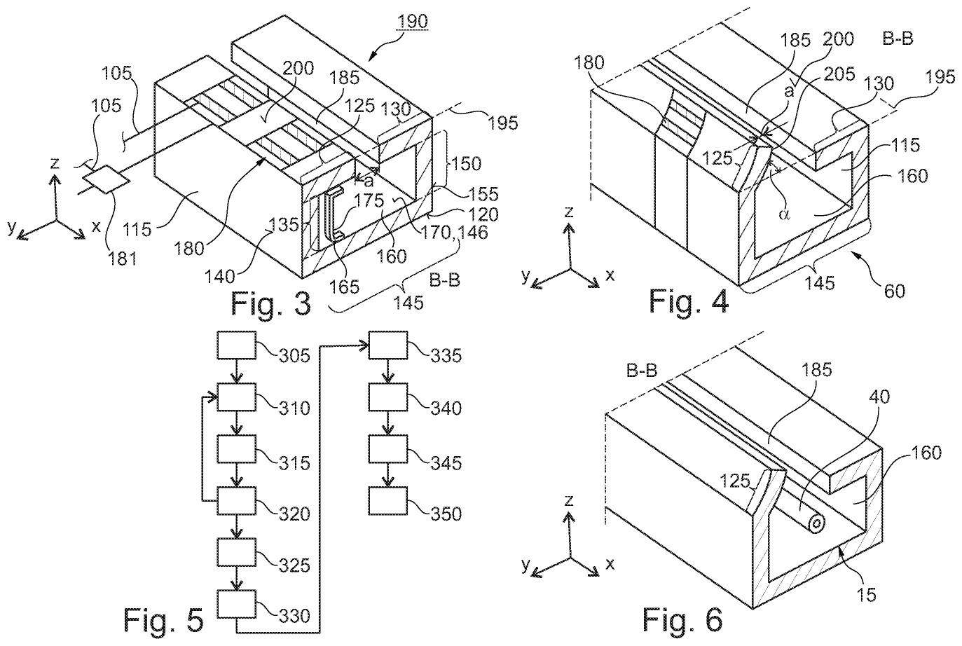

FIG. 3 shows a detail of a sectional view along a cutting plane B-B shown in FIG. 2 through the system 10 shown in FIGS. 1 and 2.

The first portion 125 on the upper side adjoins a first side portion 135 of the mold body 115, wherein the first side portion 135 on the outside has a first side surface 140. The first side surface 140 can run at least partially, for example, in an xz-plane. The first side portion 135 can be configured to be plate-like or oriented to run at least parallel to the z-axis. On the lower side the first side portion 135 adjoins a bottom portion 145 of the mold body 115. The bottom portion 145 on the upper side adjoins the lower side 120 of the mold body 115 and is configured to run in a substantially plate-like manner parallel to the first upper side 70 of the mold board 65. The first side portion 135 runs perpendicularly to the bottom portion 145 and is connected to the bottom portion 145 on the lower side. The bottom portion 145 can be configured identically, substantially over the entire extent of the adaptable manufacturing mold 60 in the vertical direction.

Parallel to the first side portion 135 the mold body 115 has a second side portion 150. On the outer side, the second side portion 150 adjoins a second side surface 155. The second side portion 150 runs by way of example parallel to the first side surface 140 and perpendicularly to the bottom portion 145. The second side portion 150 connects the second portion 130 to the bottom portion 145 in the vertical direction. The second side portion 150 is connected to the second portion 130 on a side remote from the first portion 125.

The mold body 115 has a mold cavity 160 on the inside of the mold body 115, wherein in FIGS. 2 and 3 by way of example the mold cavity 160 is delimited on the lower side by the bottom portion 145 and laterally by the first side portion 135 and the second side portion 150 and on the upper side by the first and second portion 125, 130.

Support ribs 165 (particularly clearly identifiable in FIG. 2), which are configured in one piece and in one material with the mold body 115, can be provided in the mold cavity 160. The support ribs 165 are configured in the manner of webs and protrude into the mold cavity 160. Each of the support ribs 165 has a bearing surface 175, wherein the bearing surface 175 is offset inwardly relative to an inner peripheral side 170 of the mold body 115 with which the mold body 115 delimits the mold cavity 160 by the portions, side portions and bottom portions 125, 130, 135, 145, 150. The support rib 165 can be configured, for example, to run in a yz-plane.

The inner peripheral side 170 has a mold base 146 on the bottom portion 145, wherein by way of example the mold base 146 runs substantially parallel to the lower side 120 of the mold body 115. In the embodiment, the mold base 146 is configured by way of example in a planar manner.

Recesses (not shown in FIG. 3) can be provided in the mold base 146 in order to receive further components of the cable harness 15 when manufacturing the cable harness 15. For example, a holding element can be positioned in the recess for fixing the cable harness 15 in a body element of a vehicle body.

The adaptable manufacturing mold 60 has at least one first actuator 180 (shown schematically in FIG. 3). Preferably the first actuator 180 is configured as a soft robotic module. For example, the first actuator 180 can be configured as a dielectric elastomer actuator. In order to show the first actuator 180, the first portion 125 is shown cut away in FIG. 3.

The first actuator 180 is coupled via the third connection 105 to the interface 90. The adaptable manufacturing mold 60 can also have a control module 181 which is connected to the third connection 105. The control module 181 is also electrically connected to the first actuator 180. On the basis of the data signal transmitted via the third connection 105, the control module 181 activates a power supply of electrical energy to the first actuator 180 or the control module 181 interrupts the power supply or changes the polarity of the electrical power supply to the first actuator 180.

In the embodiment, the first actuator 180 is embedded in the first portion 125. Embedding is understood to mean that the first actuator 180 is fully enclosed by the first material of the mold body 115, so that a peripheral side of the first actuator 180 does not protrude from the mold body 115 either on the inside or on the outside. As a result, the peripheral side of the first actuator 180 is entirely covered by the first material of the mold body 115. This design has the advantage that the mold body 115 can be particularly easily cleaned. Moreover, damage to the first actuator 180 can be prevented.

As an alternative to the design shown in FIG. 3, a positioning of the first actuator 180 on the outside, for example on a side remote from the mold cavity 160, for example a second upper side 200 of the mold body 115, could also be possible. For example, the first actuator 180 can be connected on the lower side by a material connection to the second upper side 200. The material connection can be configured, for example, as an adhesively bonded connection.

In the embodiment, the first actuator 180 extends exclusively in/on the first portion 125. Naturally, it might also be conceivable that the first actuator 180 is configured differently and extends, for example, over the first portion 125 and the first side portion 135 or other portions 130, 135, 150 of the mold body 115.

In the embodiment, the first actuator 180 extends substantially over the entire longitudinal extent of the first portion 125. The first actuator 180 can also extend in some regions in the longitudinal direction and/or transverse direction.

It is particularly advantageous if the first actuator 180 extends primarily in the transverse direction of the first portion 125. The first actuator 180 extends over at least 50%, preferably over 80%, of the first portion 125. It is particularly advantageous if the extent in the transverse direction is less than 95%, in particular less than 90%, of a maximum extent in the transverse direction of the first portion 125.

An opening 185 is provided in the transverse direction between the first portion 125 and the second portion 130. The opening 185 is configured as a slot and opens on the inside into the mold cavity 160. The opening 185 opens out on the outside at the second upper side 200. The opening 185 is configured, for example, such that the first and second portion 125, 130 are arranged spaced apart in the transverse direction. The first portion 125 and the second portion 130 are configured at an obtuse angle at the opening 185. It might also be conceivable that the first and second portion 125, 130 run at an acute angle to one another. The first and second portion 125, 130 could also bear against one another at the opening 185 and thus entirely close the opening 185.

The first portion 125 is reversibly and non-destructively pivotable between a first position (shown in FIG. 3) and a second position (shown in FIG. 4). In the first position, the first portion 125 and the second portion 130 are arranged in a common plane 195 which is configured, for example, as the xy-plane. In the first position by way of example, the first portion 125 runs parallel to the mold base 146 and to the mold board 65. In the first position of the first portion 125, a minimum spacing a is minimized in the transverse direction between the first portion 125 and the second portion 130. The minimum spacing a corresponds to an opening width of the opening 185.

If the first portion 125 is in the first position, the first portion is configured, for example, to be plate-shaped and extends in substantially rectilinear manner along the x-axis and y-axis. The first actuator 180 can be deactivated in the first position of the first portion 125. In order to manufacture such an adaptive manufacturing mold 60, when molding the mold body 115, for example in an injection mold, the original mold for molding the mold body 115 can substantially be a negative mold relative to the design shown in FIGS. 1 to 3 of the mold body 115 and in the deactivated state the first actuator 180 can be inserted into this original mold. Alternatively, the mold/original mold can also be 3D printed or milled.

Naturally, in the first position of the first portion 125 the first actuator 180 can also be activated so that the first actuator 180 holds the first portion 125 in the first position. In this case, for example, the mold body 115 can be shaped such that the first portion 125 is shaped, for example, to be (bent) upward in the relaxed state.

FIG. 4 shows the detail shown in FIG. 3 of the sectional view along the cutting plane B-B shown in FIG. 1.

In FIG. 4 the first portion 125 is shown in the second position. In the second position, the first portion 125 is bent away upwardly in a direction from the bottom portion 145 and from the mold base 146. In the second position in FIG. 4, the first portion 125 is configured to be bent upwardly about the x-axis. The minimum spacing a between the first portion 125 and the second portion 130 is enlarged relative to the minimum spacing a shown in FIG. 3 and the opening 185 is widened as a result relative to FIG. 3.

In the second position the mold body 115 is deformed in an elastically reversible manner relative to the first position. In FIG. 4 by way of example the first portion 125 is deformed, in particular bent, sufficiently far that a free end 205 of the first portion 125, which delimits the opening 185, encloses an angle α together with the plane 195, wherein the angle α is at least 20°, preferably at least 40°, preferably at least 60°. Preferably, the angle α is less than or equal to 90°, in particular less than or equal to 70°. In the second position the free end 205 is arranged above the second upper side 200 of the second portion 130. In other words, by way of example, the first portion 125 is pivoted away and arranged spaced apart from the mold base 146. Alternatively, it might also be possible that in the second position the first portion 125 is pivoted inwardly into the mold cavity 160, so that the opening 185 is enlarged thereby.

In order to transfer the first portion 125 from the first position (see FIG. 3) into the second position (see FIG. 4), the control device 80 controls the first actuator 180 via a first control signal which is configured as a data signal and which the control device 80 provides at the interface 90. The first actuator 180 moves the first portion 125 from the first position into the second position. The first actuator 180 can mechanically brace the mold body 115, in particular the first portion 125, so that the first portion 125 forms a bar spring. In order to hold the first portion 125 in the second position, the first actuator 180 can be continuously activated.

By pivoting the first portion 125 upwardly or into the mold cavity 160 by the angle α, the opening 185 is widened sufficiently far that the electrical cables 40, 45 can be inserted in an automated manner into the mold cavity 160 by the laying device 55.

Also by the first portion 125 being bent up/bent down by the first actuator 180, the adaptable manufacturing mold 60 is also particularly suitable for the manual insertion of the electrical cables 40, 45 into the mold cavity 160, since the opening 185 can be gripped particularly easily with the fingers without the adaptable manufacturing mold 60 being damaged and/or the fingers being trapped or injured in the opening 185.

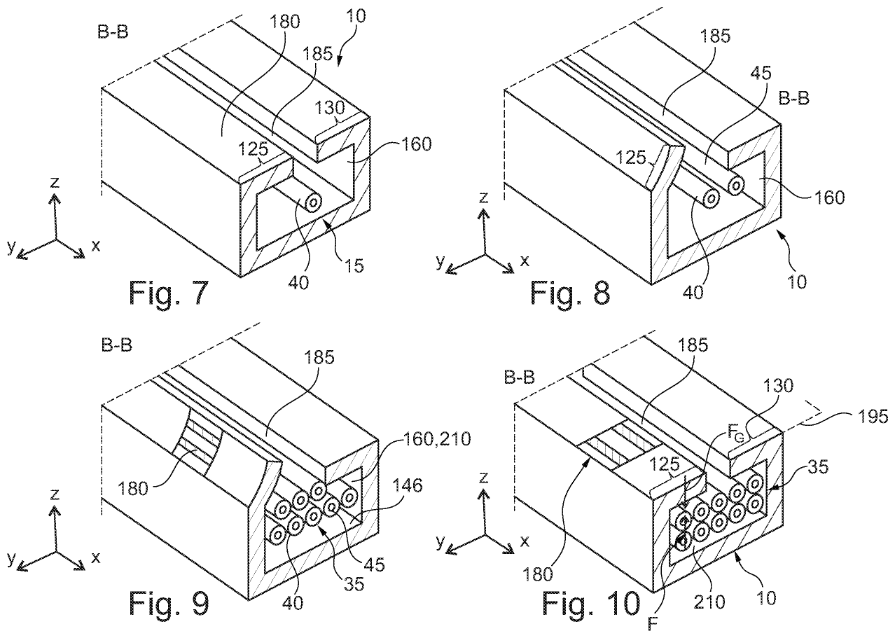

FIG. 5 shows a flow diagram of a method for the automated manufacture of the cable harness 15 according to a first embodiment. FIG. 6 shows a detail of a sectional view along the cutting plane B-B shown in FIG. 2 through the system 10 during a third method step 315. FIG. 7 shows a detail of a sectional view along the cutting plane B-B shown in FIG. 2 through the system 10 after a fourth method step 320. FIG. 8 shows a detail along a cutting plane B-B shown in FIG. 1 through the system 10 shown in FIG. 1 during a second pass of the third method step 315. FIG. 9 shows a detail along the cutting plane B-B shown in FIG. 2 through the system 10 shown in FIG. 1 after a repeated pass of the third method step 315. FIG. 10 shows a detail along a cutting plane B-B shown in FIG. 1 through the system 10 during an eighth method step 340 for manufacturing the cable harness 15.

The system 10 shown in FIG. 1 is provided in a first method step 305. The first portion 125, for example, is in the first position.

In a second method step 310 (see FIG. 4), the control device 80 controls the first actuator 180 on the basis of the control method stored in the data storage device 85 via the first control signal provided at the interface 90 and transmitted via the third connection 105, such that the first actuator 180 moves the first portion 125 from the first position into the second position. As a result, the opening 185 is widened. The first portion 125 is also braced by the first actuator 180.

In the third method step 315 (see FIG. 6) carried out in parallel with the second method step 310, the control device 80 controls the laying device 55 by means of at least one second control signal which is configured as a data signal and provided at the interface 90 of the fourth connection 110 for transmitting to the laying device 55, such that the laying device 55 inserts the first electrical cable 40, for example from a cable store, (not shown in FIG. 1) via the widened opening 185 into the mold cavity 160. The first electrical cable 40 can be positioned in each case on the bearing surface 175 of the support ribs 165. The first electrical cable 40 is supported by the support ribs 165 such that the first electrical cable 40 runs substantially spaced apart from the mold base 146. As the second and third method steps 310, 315 are carried out in parallel, the insertion of the first electrical cable 40 is facilitated for the laying device 55 and due to the widened opening 185 the first electrical cable 40 is prevented from becoming caught when inserted into the mold cavity 160, for example on the first and/or second portion 125, 130.

In a fourth method step 320 (see FIG. 7) following the third method step 315, the control device 80 controls the first actuator 180 by means of a third control signal configured as a data signal, such that the first actuator 180 moves the first portion 125 back from the second position into the first position. For example, the control device 80 can deactivate the first actuator 180 by means of the third control signal, such that the first portion 125 is relaxed and automatically moves back into the first position.

The first actuator 180 can also be controlled by the third control signal such that the first actuator 180 actively moves the first portion 125 into the first position. In the first position the minimum spacing a between the first portion 125 and the second portion 130, which corresponds to the opening width of the opening 185, is preferably selected such that the minimum spacing a is smaller than a minimum external diameter of the (thinnest) of the electrical cables 40, 45 which are inserted into the mold cavity 160 for forming the cable harness 15. As a result, the situation is avoided that the electrical cable 40, 45, in FIG. 7 for example the first electrical cable 40, slips out of the mold cavity 160.

After the fourth method step 320, the second to fourth method steps 310, 315, 320 are repeated (see FIG. 8), wherein in the third method step 315, however, the second electrical cable 45 is inserted into the mold cavity 160 instead of the first electrical cable 40. The insertion of the second electrical cable 45 by the laying device 55 is also facilitated by the first portion 125, which is movable into the second position, since as a result the opening 185 is widened and the second electrical cable 45 can be introduced particularly easily into the mold cavity 160 with the first electrical cable 40.

The second to fourth method steps 310 to 320 are repeated until the laying device 55 has inserted all of the electrical cables 40, 45 into the mold cavity 160 for manufacturing the cable harness 15. The electrical cables 40, 45 together form the cable bundle 35 (see FIGS. 9 and 10).

After all of the electrical cables 40, 45 have been inserted into the mold cavity, the fourth method step 320 is continued with a fifth method step 325.

The fifth method step 325 is substantially identical to the second method step 310, such that the first actuator 180 is activated by means of a new first control signal and the first actuator 180 moves the first portion 125 from the first position into the second position. The opening 185 is widened again thereby.

In a sixth method step 330 following the fifth method step 325, the control device 80 controls the laying device 55 by means of a fourth control signal such that the laying device 55 introduces, for example, a foamed material 210 into the mold cavity 160 via the opening 185.

The foamed material 210 can be introduced, in particular injection-molded, for example in liquid or viscous form, into the mold cavity 160. The foamed material 210 is applied, for example, on the upper side onto the cable bundle 35. The foamed material 210 sags in the mold cavity 160 due to gravity in the direction of the mold base 146.

The foamed material 210 flows around the electrical cables 40, 45 such that the electrical cables 40, 45 are at least partially, preferably entirely, embedded in the foamed material 210. By the arrangement of the support ribs 165 in the mold cavity 160 it is ensured that the electrical cables 40, 45 are also enclosed by the foamed material 210 on the lower side. A seventh method step 335 continues after the foamed material 210 has been introduced by the laying device 55.

The seventh method step 335 is configured substantially identically to the fourth method step 320. The control device 80 controls the first actuator 180 by means of a fifth control signal such that the first actuator 180 moves the first portion 125 from the second position back into the first position. For example, the control device 80 can deactivate the first actuator 180 by means of the fifth control signal and switch off the power supply so that the first portion 125 is relaxed and moves automatically back into the first position. Alternatively, the first actuator 180 is actively moved into the first position by means of the fifth control signal.

As the first portion 125 and the second portion 130 are arranged in the common plane 195 and the opening 185 is closed or the opening width of the opening 185 is minimized, in the seventh method step 335 the situation is avoided that the electrical cables 40, 45 float above the foamed material 210 while the foamed material 210 is curing. As a result, the electrical cables 40, 45 of the cable bundle 35 are substantially fully embedded in the foamed material 210.

The support ribs 165 ensure that the foamed material 210 substantially fully encloses the cable bundle 35 on the peripheral side, so that the electrical cables 40, 45 are mechanically protected from damage by the foamed material 210 and/or are mechanically connected to one another by a material connection 210 via the foamed material.

When the foamed material 210 swells and is cured, the foamed material 210 pushes from below with a force F against the first and second portion 125, 130.

Preferably, in an eighth method step 340 following the seventh method step 335 (see FIG. 10), the first actuator 180 is activated by the control device 80 by means of the fifth control signal which is provided via the third connection 105 from the interface 90, such that the first actuator 180 provides a counter-force F_{G} counter to the force F. The counter-force F_{G} acts in the direction of the mold base 46 (for example parallel to the z-axis). The first actuator 180 is preferably activated such that the counter-force F_{G} substantially cancels the force F.

As a result, it is ensured that the situation is avoided that the first portion 125 is bent up. Moreover, when the foamed material 210 swells it can also be ensured thereby that the first and second portion 125, 130 remain in the common plane 195. This also ensures that the cable harness 15 has a substantially predefined geometric design on the peripheral side, for example similar to a rectangle in cross section.

Preferably, the counter-force F_{G} is maintained during substantially the entire curing process of the foamed material 210.

A ninth method step 345 continues after the eighth method step 340, wherein the ninth method step 345 is substantially identical to the second method step 310. The first actuator 180 is activated by means of a further first control signal, so that the first actuator 180 moves the first portion 125 from the first position into the second position and holds the first portion 125 in the second position. The first portion 125 is detached on the inside relative to the foamed material 210. This can be assisted by a separating agent applied to the inner peripheral side 170.

In a tenth method step 350, the cable harness 15 is removed with the at least partially cured foamed material 210 from the mold cavity 160 through the opened opening 185, for example by the laying device 55. The tenth method step 350 is partially carried out in parallel with the ninth method step 345. The control device 80 controls the first actuator 180 such that the first actuator holds the first portion 125 in the second position during the removal of the cable harness 15. As a result, a simple removal of the cable harness 15 from the mold cavity 160 is ensured.

By opening and widening the opening 185 the laying device 55 can grip the cable harness 15 particularly easily and remove it automatically from the mold cavity 160. The mold body 115, in particular the second portion 130 and/or the first and/or second side portion 135, 150, can yield in an elastically reversible manner and, for example, the second portion 130 can be bent up reversibly.

FIG. 11 shows a detail of a sectional view along the cutting plane B-B shown in FIG. 2 through a system 10 according to a second embodiment.

The adaptable manufacturing mold 60 is configured substantially identically to the adaptable manufacturing mold 60 described in FIGS. 1 to 4 and 6 to 10. Hereinafter only the differences between the adaptable manufacturing mold 60 shown in FIG. 11 and the adaptable manufacturing mold 60 shown in FIGS. 1 to 4 and 6 to 10 are discussed in detail.

In addition to the adaptable manufacturing mold 60 shown in FIGS. 1 to 4 and 6 to 10, the adaptable manufacturing mold 60 shown in FIG. 11 also has a second actuator 215. For a schematic view of the second actuator 215, the second portion 130 is shown cut away in FIG. 11.

Moreover, the adaptable manufacturing mold 60 shown in FIG. 11 is varied relative to the adaptable manufacturing mold 60 shown in FIGS. 1 to 10, such that the first actuator 180 is not only arranged and preferably embedded in the first portion 125 but also in the first side portion 135.

In an alternative, the first actuator 180 can be arranged on the second upper side 200 and/or on the first side surface 140 on the mold body 115. Alternatively, it is also possible that the first actuator 180 is arranged in/on the first side portion 135 and an arrangement of the first actuator 180 in/on the first portion 125 is dispensed with. Preferably, the first actuator 180 is connected by a material connection, for example, to the second upper side 200 of the first portion 125 and/or the first side surface 140. If the first actuator 180 is exclusively arranged in/on the first side portion 135, the first actuator 180 is indirectly connected to the first portion 125.

The second actuator 215 can be configured mirror-symmetrically to the first actuator 180. In FIG. 11 by way of example, the second actuator 215 extends in the second portion 130 and/or in the second side portion 150. The second actuator 215 can be embedded in the second portion 130 and/or in the second side portion 150 in the mold body 115.

Alternatively, the second actuator 215 can be arranged on the second upper side 200 of the second portion 130 and/or on the second side surface 155 of the second side portion 150 and preferably connected by a material connection to the mold body 115 on the second upper side 200 of the second portion 130 and/or on the second side surface 155 of the second side portion 150. If the first actuator 180 is exclusively arranged in/on the second side portion 150, the first actuator 180 is indirectly connected to the second portion 130.

The second actuator 215 is connected via a fifth connection 219 to the interface 90. A further control module (not shown in FIG. 11) can also be provided between the interface 90 and the second actuator 215. The further control module is also electrically connected to the second actuator 215. On the basis of a sixth or seventh control signal transmitted via the fifth connection 219, the control module 181 activates an electrical power supply of electrical energy to the first actuator 180 or the control module 181 interrupts the power supply of the second actuator 215 or changes a polarity of the electrical power supply. By means of the sixth or seventh control signal, the second actuator 215 can be activated such that the second actuator 215 moves the second portion 130, and in FIG. 11 additionally the second side portion 150, between a third position and a fourth position. In FIG. 11 the second portion 130 and the second side portion 150 are shown in the third position. In the third position of the second portion 130 and the second side portion 150, the second actuator 215 can be deactivated or the power supply disconnected. The second actuator 215 can be configured identically to the first actuator 180.

In the third position, the second portion 130 runs in the plane 195 and thus is oriented parallel to the mold base 146. In the third position, the first side portion 135 and the second side portion 150 also run parallel to one another and, for example, substantially perpendicular to the mold base 146.

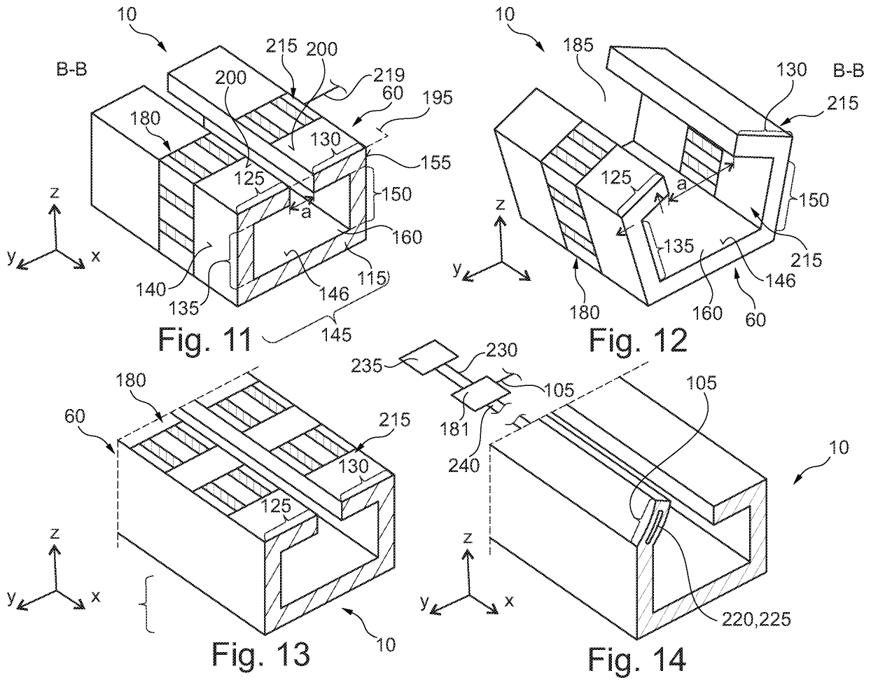

FIG. 12 shows the sectional view shown in FIG. 11 with the adaptable manufacturing mold 60 shown in FIG. 11 in the open state.

In FIG. 12 both the first actuator 180 is activated by the first control signal and the second actuator 215 is activated by the sixth control signal at the same time by the control device 80 via the interface 90. The first actuator 180 pivots the first portion 125 into the second position. Additionally, the first actuator 180 pivots the first side portion 135 outwardly in the second position such that the mold cavity 160 is widened relative to the design shown in FIG. 11 in the transverse direction. Both the first portion 125 and the first side portion 135 are bent about the x-axis. The first side portion 135 is bent away obliquely outwardly from the mold base.

The control device 80 activates the second actuator 215 via the interface 90 and the fifth connection 220 by means of the sixth control signal such that the second actuator 215 moves the second portion 130 away from the mold base 146 upwardly into the fourth position. The second actuator 215 also pivots the second side portion 150 in the fourth position outwardly away from the first side portion 135, so that the mold cavity 160 is widened. In the fourth position, the second side portion 150 is pivoted away obliquely outwardly from the mold base 146 and from the first side portion 135.

This design has the advantage that the minimum spacing a between the first portion 125 and the second portion 130, which corresponds to the opening width of the opening 185, can be enlarged particularly significantly relative to the minimum spacing a shown in FIG. 11, such that the insertion of the electrical cables 40, 45 for forming the cable bundle 35 and the injection-molding of the foamed material 210 into the mold cavity 160 by means of the laying device 55, and the removal of the finished cable harness 15 are facilitated.

The design shown in FIGS. 11 and 12 is also particularly well suited for the insertion of the electrical cables 40, 45 manually, in particular by hand, into the mold cavity 160.

The method according to a second embodiment for manufacturing the cable harness 15 is substantially identical to the method described in FIG. 5. Hereinafter reference is only made to the differences between the method according to the second embodiment and the manufacturing method according to the first embodiment which is described in FIG. 5. However, the first actuator 180 also pivots the first side portion 135 between the first position (oriented parallel to the z-axis) and the second position (pivoted outwardly).

Additionally, the control device 80 activates the second actuator 215 by means of the fifth control signal in the second method step 310 such that the second actuator 215 moves at least the second portion 130 and the second side portion 150 from the third position into the fourth position, such that the second portion 130 is bent away upwardly from the mold base 146 and the second side portion 150 is pivoted outwardly from the first side portion 135, such that the mold cavity 160 is widened as a whole. The second portion 130 and the second side portion 150 are bent open. The control device 80 can also activate the second actuator 215 such that it is preferably pivoted in a similar manner to the first portion 125 into the mold cavity 160. It might also be possible that the first portion 125 and the second portion 130 are arranged in opposing directions in the second position and the fourth position. One of the two portions 125, 130 can be pivoted away from the mold base 146 and the other portion 125, 130 can be pivoted/bent into the mold cavity 160.

In the fourth method step 320 the control device 80 activates the second actuator 215 by means of the sixth control signal in addition to the first actuator 180, such that the second portion 130 and the second side portion 150 are pivoted back or pivoted from the fourth position into the third position, and as a result in the mold cavity 160 the first and second portions 125, 130 hold the electrical cable(s) 40, 45 inserted into the mold cavity 160.

For example, the second side portion 150 is also pivoted from the fourth position into the third position in the direction of the first side portion 135 such that the mold cavity 160 adopts its original design again.

The transfer from the fourth position into the third position can take place actively, such that the second actuator 215 is supplied with electrical energy and actively pivots back the second portion 130 and the second side portion 150. Alternatively, the second actuator 215 can be deactivated and the second portion 130, which is braced in the second method step, and the second side portion 150 are relaxed.

As a result, in the fourth method step the opening 185 is either closed or the minimum spacing a is minimized. As a result, the electrical cables 40, 45 inserted into the mold cavity 160 via the opening 185 are prevented from slipping out.

Similar to the second and fourth method step 310, 320, in the fifth method step 325 the second actuator 215 is controlled by the control device 80 by means of the fifth control signal such that before the foamed material 210 is introduced into the mold cavity 160, the second actuator 215 pivots the second portion 130 upwardly and pivots the second side portion 150 away outwardly into the fourth position.

After the foamed material 210 is introduced, in the seventh method step 335 the control device 80 additionally activates the second actuator 215 such that the second actuator 215 pivots the second side portion 150 inwardly back in the direction of the first side portion 135, and pivots the second portion 130 back from the fourth position into the third position. This can take place as described above actively.

Additionally, in the seventh method step 335 together with the first actuator 180 the control device 80 can activate the second actuator 215 and the first actuator 180 such that the second actuator 215 provides the counter-force F_{G} in order to prevent the second portion 130 and optionally the first and second side portion 135, 150 from bending up due to the foaming of the foamed material 210.

In the ninth method step 345, similar to the second and sixth method step 310, 330, the control device 80 activates the second actuator 215 such that it pivots the second portion 130 and the second side portion 150 again from the third position into the fourth position outwardly away from the mold base 146 in order to ensure an effective removal of the cable harness 15 from the mold cavity 160.

FIG. 13 shows a detail of a sectional view along a cutting plane B-B shown in FIG. 2 through a system 10 according to a third embodiment.

The system 10 shown in FIG. 13 is a combination of the systems 10 shown in FIGS. 1 to 4, 6 to 12.

Hereinafter only the differences between the system 10 shown in FIG. 13 and the system 10 shown in FIGS. 11 and 12 are discussed in detail.

In FIG. 13 the second actuator 215 is configured substantially identically to the first actuator 180, wherein the first actuator 180 is configured as described in FIGS. 1 to 10. As a result, the first actuator 180 by way of example extends exclusively in/on the first portion 125. The second actuator 215 is arranged exclusively in/on the second portion 130. This design has the advantage that the first actuator 180 and the second actuator 215 are configured particularly simply and cost-effectively. The arrangement of the second actuator 215 in the second portion 130 has the advantage that the opening 185 can be widened further relative to the design of the system 10, shown in FIGS. 1 to 10. In FIG. 13 the second actuator 215 is activated by means of the fifth control signal such that the second actuator 215 moves the second portion 130 upwardly away from the mold base 146 out of the third position into the fourth position, wherein in the fourth position the second portion 130 is not configured to be plate-shaped as in the third position but to be bent upwardly.

The manufacturing method corresponds substantially to the method described in FIG. 12. The first and second side portions 135, 150 are arranged throughout the method substantially parallel to one another and remain in this position during the implementation of the method.

FIG. 14 shows a detail of a sectional view along the cutting plane B-B shown in FIG. 2 through a system 10 according to a fourth embodiment.

The system 10 is configured substantially identically to the systems 10 shown in the above figures. Hereinafter only the differences between the system 10 shown in FIG. 14 and the system 10 shown in FIGS. 1 to 10 are discussed in more detail.

The first actuator 180 has a pressure chamber 220, wherein the pressure chamber 220 can be filled with a pressurized fluid 225. The pressure chamber 220 is fluid-tight. The pressure chamber 220 can be configured as a tubular free space in the first portion 125.

The pressurized fluid 225 can be compressed air, for example. The pressurized fluid 225 can also be a liquid, for example water or a hydraulic liquid. The control module 181 can have a multiway valve which is fluidically connected by means of a first fluid line 230 to a pressure accumulator 235. The pressure accumulator 235 stores the pressurized pressure fluid 225. The control module 181 is also fluidically connected by means of a second fluid line 240 to the pressure chamber 220. The control module 181 is also connected in terms of data technology to the interface 90 by means of the third connection 105.

The mold body 115 is configured such that the mold body 115 adopts the first position and optionally the third position, should a second actuator 215 be provided, for example in the depressurized state of the pressure chamber 220.

The control device 80 activates the first actuator 180 via the control module 181. The control module 181 connects the pressure chamber 220 fluidically to the pressure accumulator 235 when the first control signal is provided, such that the pressure fluid 225 flows out of the pressure accumulator 235 in a pressurized manner into the pressure chamber 220.

By the application of pressure, for example, the first portion 125 is pivoted upwardly away from the mold base 146 so that the opening 185 is widened as shown in FIG. 14.

In order to move the first portion 125 from the second position into the first position, the control module 181 disconnects the fluidic connection between the pressure chamber 220 and the pressure accumulator 235 and permits an outflow of pressure fluid 225 from the pressure chamber 220. The material of the mold body 115 forces the de-pressurized fluid 225 out of the pressure chamber 220. By the de-pressurization of the pressure fluid 225, the first portion 125, which is braced when pivoted from the first position into the second position, is relieved of pressure and due to the pressure relief the first portion 125 moves from the second position back into the first position.

Alternatively, it might also be conceivable that pressure is applied to the pressure fluid 225 in the pressure chamber 220 when the first portion 125 is in the first position and, for transferring the first portion 125 into the second position, the pressure fluid 225 is de-pressurized in the pressure chamber 220. In this case, the first material of the mold body 115 is braced in the first position by the pressurized pressure fluid 225 while in the second position the first material of the first portion 125 is de-pressurized. This design has the advantage that, in particular in the eighth method step 340, by the application of pressure to the pressure fluid 225 in the pressure chamber 220, the actuating force FB can be provided in a simple manner in order to counteract the force F of the foaming foamed material 210 and to ensure that the cable bundle 35 is reliably held down in the mold cavity 160.

In summary, the adaptable manufacturing mold 60 provides the possibility of manufacturing the cable harness 15 in a fully automated manner. The insertion of the electrical cables 40, 45 can also be facilitated and as a result can be carried out in a fully automated manner by the laying device 55.

In a development, the system 10 shown in FIGS. 1 to 14 for a manual insertion of the electrical cables 40, 45 into the mold cavity 160 can be adapted such that, for example, a switch is provided. The first actuator 180 and/or the second actuator 215 can be controlled by means of the switch which is operated by the person carrying out the insertion and which, for example, can be configured as a foot-operated switch.

As a result, the operator can widen the opening 185 in a simple manner in order to make the mold cavity 160 easily accessible when manually inserting the electrical cables 40, 45 and to close the mold cavity 160 again by the first and/or second actuator 180, 215 by means of the switch after the electrical cable 40, 45 has been inserted.

1. A manufacturing mold for manufacturing a cable harness for a vehicle,
wherein the manufacturing mold comprises a mold body and at least a first actuator,
wherein the mold body is made from an elastically reversibly deformable material and at least partially surrounds a mold cavity,
wherein the first actuator is coupled to a first portion of the mold body,
wherein the first portion at least partially delimits the mold cavity on the inside,
wherein the cable harness can at least be manufactured in the mold cavity,
wherein the first actuator is designed to reversibly pivot the first portion between a first position and a second position that is different from the first position.

2. The manufacturing mold as claimed in claim 1,
wherein the mold body has an opening for introducing at least one electrical cable into the mold cavity,
wherein the opening opens into the mold cavity,
wherein the first portion adjoins the opening,
wherein in the second position of the first portion the opening is widened relative to the first position of the first portion.

3. The manufacturing mold as claimed in claim 1,
wherein the mold body has a mold base,
wherein in the first position the first portion is oriented parallel or inclined obliquely to the mold base,
wherein in the second position the first portion is spaced further apart from the mold base than in the first position,
or
wherein in the second position the first portion is arranged closer to the mold base than in the first position.

4. The manufacturing mold as claimed in claim 1,
wherein the adaptable manufacturing mold has a second actuator,
wherein the mold body has a second portion,
wherein the second portion is arranged offset to the first portion,
wherein the second actuator is arranged on and/or in the second portion,
wherein the second actuator is configured to pivot the second portion reversibly between a third position and a fourth position which is different from the third position.

5. The manufacturing mold as claimed in claim 4,
wherein the opening extends in its main direction of extension in a first direction,
wherein the second portion is arranged opposite the first portion in a second direction perpendicular to the first direction and at least partially delimits the opening opposite the first portion,
wherein in the first position of the first portion and in the third position of the second portion, the opening has a first minimum opening width in the second direction,
wherein in the second position of the first portion and in the fourth position of the second portion, the opening has a second minimum opening width in the second direction which is larger than the first opening width.

6. The manufacturing mold as claimed in claim 1,
wherein the first actuator is arranged on the outside of the mold body,
and/or
wherein the first actuator is at least partially embedded in the mold body.

7. The manufacturing mold as claimed in claim 1,
wherein the first actuator has at least one pressure chamber,
wherein the pressure chamber can be filled with a pressurized pressure fluid in order to move the first portion between the first position and the second position
and/or
wherein the first actuator is configured as a dielectric elastomer actuator.

8. The manufacturing mold as claimed in claim 1,
wherein the first actuator is configured to deform the mold body in an elastically reversible manner when the first portion is pivoted between the first position and the second position.

9. The manufacturing mold as claimed in claim 1,
wherein in the second position the first portion encloses an angle relative to the first position,
wherein the angle is at least 20°.

10. A system
having a control apparatus and an adaptable manufacturing mold as claimed in claim 1,
wherein the control apparatus is connected to the first actuator,
wherein the control apparatus is configured to control the first actuator such that the first actuator moves the first portion between the first position and the second position.

11. A method for manufacturing a cable harness,
wherein an adaptable manufacturing mold as claimed in claim 1 is provided,
wherein the first actuator moves the first portion from the first position into the second position,
wherein at least a first electrical cable is inserted into the mold cavity for forming a cable bundle of the cable harness,
wherein during the insertion of the first electrical cable and/or during a removal of the cable harness from the mold cavity the first portion is in the second position.

12. The method as claimed in claim 11,
wherein after the insertion of the first electrical cable into the mold cavity the first actuator moves the first portion from the second position into the first position and in the first position the first portion secures the first electrical cable in the mold cavity.

13. The method as claimed in claim 11,
wherein the first actuator moves the first portion from the first position into the second position in order to introduce a foamed material into a mold cavity,
wherein the foamed material is introduced into the mold cavity,
wherein the foamed material flows at least partially around the cable bundle such that the cable bundle is at least partially embedded in the foamed material,
wherein the foamed material is at least partially cured.

14. The method as claimed in claim 13,
wherein the first actuator is activated during the foaming of the foamed material such that the first actuator provides a counter-force which reduces or prevents the first portion from bending up due to the foaming foamed material.

15. The method as claimed in claim 13,
wherein the foamed material is at least partially cured,
wherein after the at least partial curing of the foamed material the first actuator moves the first portion from the first position into the second position and the cable harness is removed from the mold cavity.

16. The method as claimed in claim 11,
wherein an adaptable manufacturing mold is provided,
wherein for inserting the first electrical cable into the mold cavity the second actuator moves the second portion from the third position into the fourth position,
wherein the first electrical cable is inserted into the mold cavity between the first portion and the second portion.

17. The method as claimed in claim 11,
wherein the first actuator deforms the mold body in an elastically reversible manner when the first portion is pivoted between the first position and the second position.

18. A manufacturing mold for manufacturing a cable harness for a vehicle,
wherein the manufacturing mold comprises a mold body and at least a first actuator and a second actuator,
wherein the mold body is made from an elastically reversibly deformable material and at least partially surrounds a mold cavity,
wherein the first actuator is coupled to a first portion of the mold body and the second actuator is arranged on and/or in a second portion of the mold body,
wherein the first portion at least partially delimits the mold cavity on the inside,
wherein the cable harness can at least be manufactured in the mold cavity,
wherein the first actuator is designed to reversibly pivot the first portion between a first position and a second position that is different from the first position,
wherein the second portion is arranged offset to the first portion,
wherein the second actuator is configured to pivot the second portion reversibly between a third position and a fourth position which is different from the third position,
wherein in the second position of the first portion and in the forth position of the and the opening is widened relative to the first position of the first portion and the third position of the second portion.

19. A manufacturing mold for manufacturing a cable harness for a vehicle,
wherein the manufacturing mold comprises a mold body and at least a first actuator,
wherein the mold body is made from an elastically reversibly deformable material and at least partially surrounds a mold cavity,
wherein the first actuator is coupled to a first portion of the mold body,
wherein the first portion at least partially delimits the mold cavity on the inside,
wherein the cable harness can at least be manufactured in the mold cavity,
wherein the first actuator is designed to reversibly pivot the first portion between a first position and a second position that is different from the first position,
wherein the first actuator has at least one pressure chamber,
wherein the pressure chamber can be filled with a pressurized pressure fluid in order to move the first portion between the first position and the second position
and/or
wherein the first actuator is configured as a dielectric elastomer actuator.
